(19) United States
(12) Patent Application Publication
(10) Pub. No.: US 2011/0224829 A1
(43) Pub. Date: Sep. 15, 2011

(54) Distillation column control

(76) Inventor: Prabhu Murugan, Sugar Land, TX (US)

(21) Appl. No.: 12/661,237

(22) Filed: Mar. 12, 2010

(51) Int. Cl. G05D 9/00; B01D 3/42; G05B 19/042

(52) U.S. Cl. 700/270

(57) ABSTRACT

A method for protecting a thermal distillation column system from liquid over fill wherein instrument calibration and level signal aberrations are dynamically corrected, instrument measurement errors and measurement drifts over time are accounted for, and a decay factor component is employed to obviate the need for maintenance or periodic instrument.

### BACKGROUND OF THE INVENTION

1. Field of the Invention

This invention relates to controlling the operation of a thermal distillation tower (column). More particularly, this invention relates to preventing liquid overfill of a thermal distillation column.

2. Description of the Prior Art

Distillation columns are at the heart of many commercial chemical processes, particularly petrochemical processes.

Although this invention will be described in terms of a thermal cracking plant, it is to be understood that this invention is applicable broadly to any continuous chemical processing plant.

Thermal cracking of hydrocarbons is a petrochemical process that is widely used to produce olefins such as ethylene, propylene, butenes, butadiene, and aromatics such as benzene, toluene, and xylenes.

An olefin production plant is generally composed of a cracking unit and a hydrocarbons unit.

In the cracking unit a hydrocarbonaceous feedstock such as ethane, naphtha, gas oil, or other fractions of whole crude oil or natural gas liquids is mixed with steam which serves as a diluent to keep the hydrocarbon molecules separated.

This mixture, after preheating, is subjected to hydrocarbon thermal cracking using elevated temperatures (1,400 to 1,550 degrees Fahrenheit or F.) in a pyrolysis furnace (steam cracker or cracker). This thermal cracking is carried out without the aid of any catalyst.

The cracked product effluent of the pyrolysis furnace (furnace) contains hot, gaseous hydrocarbons of great variety (from 1 to 35 carbon atoms per molecule, or C1 to C35 inclusive, both saturated and unsaturated). This product contains aliphatics (alkanes and alkenes), alicyclics (cyclanes, cyclenes, and cyclodienes), aromatics, and molecular hydrogen (hydrogen).

This furnace product is then subjected to further processing, including thermal distillation, in the cracking unit to produce, as products of the olefin plant, various, separate and individual product streams such as hydrogen, ethylene, propylene, fuel oil, and pyrolysis gasoline. After the separation of these individual streams, the remaining cracked product contains essentially C4 hydrocarbons and heavier. This remainder is fed to a distillation tower known as a debutanizer wherein a crude C4 stream is separated as overhead while a C5 and heavier stream is removed as a bottoms product.

The C4 stream can contain varying amounts of n-butane, isobutane, 1-butene, 2-butenes (both cis and trans isomers), isobutylene, acetylenes, and diolefins such as butadiene (both cis and trans isomers).

The C5 stream can contain pentanes, pentenes, hexanes, hexenes, and aromatics such as benzene, toluene, and xylenes.

The C4 and C5 streams are further processed in the hydrocarbons unit for the separation, often by way of a thermal distillation column, of other individual product streams such as butenes, butadiene, benzene, toluene, and the like.

Typically, various levels of protection are built into a thermal distillation system to ensure safe operation of the system, particularly the distillation tower itself. These include redundant instrumentation, relief valves, safety interlocks, and continuous control systems.

In spite of such protective measures, the industry has experienced incidents in which a distillation tower was over filled with liquid, an undesirable result in respect of both the efficient operation of the system and the safety of the personnel operating the system

This invention is directed to a robust and dynamic material balance calculator for controlling the operating liquid level in a distillation column system to reduce, if not eliminate, liquid overfill incidents in respect of the distillation column itself.

### SUMMARY OF THE INVENTION

Pursuant to this invention, instrument calibration and level signal aberrations are dynamically corrected, instrument measurement errors and measurement drifts over time are accounted for, and a decay factor component is employed to obviate the need for maintenance or periodic calculation re-setting, all combined to provide better liquid accumulation data by which to operate a thermal distillation tower.

### BRIEF DESCRIPTION OF THE DRAWINGS

FIG. 1 shows a typical thermal distillation system used commercially in industry.

FIG. 2 shows a plot of data relating to a typical material balance variation from zero caused by errors in flow and/or level measurement by various instruments operating in conjunction with the system of FIG. 1.

FIG. 3 shows a plot of the data of FIG. 2, which plot indicates that liquid is accumulating in the distillation tower of FIG. 1.

FIG. 4 shows a plot based on the data of FIG. 2 which has been corrected pursuant to one aspect of this invention.

FIG. 5 shows a plot of the corrected data of FIG. 4, which plot shows that liquid is, in fact, not accumulating in the distillation tower of FIG. 1.

FIG. 6 shows the aberration of the data of FIG. 2 that can occur when measuring instruments employed in the system of FIG. 1 are re-calibrated, equipment is shut down and then later started up, and/or one or more measuring instruments are subjected to routine maintenance.

FIG. 7 shows a plot of the data of FIG. 6 after that data has been corrected by means of a decay factor in accordance with another aspect of this invention.

FIG. 8 shows a comparison plot of the data of FIGS. 6 and 7.

### DETAILED DESCRIPTION OF THE INVENTION

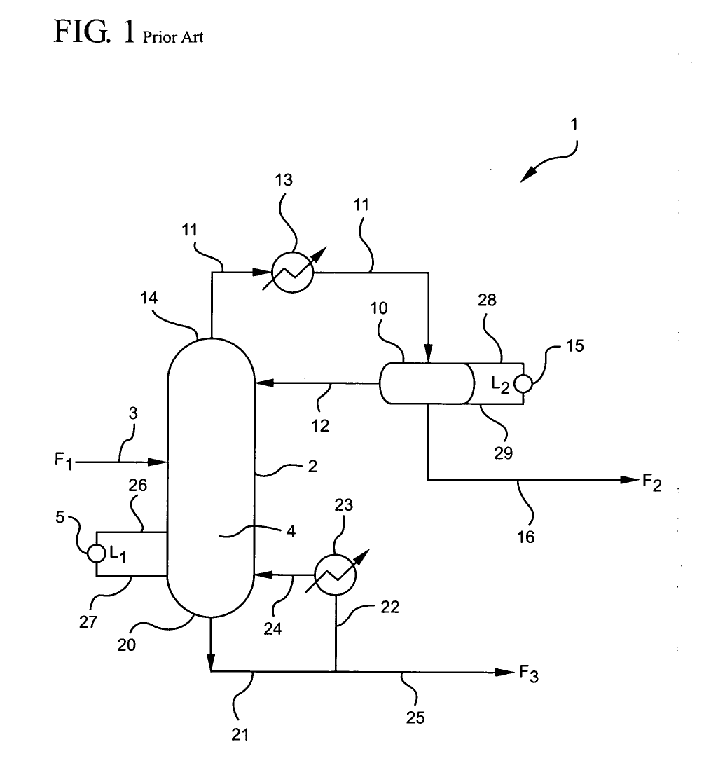

FIG. 1 shows a typical thermal distillation system 1 comprising a thermal distillation tower 2 having a single fluid feed input pipe (stream) 3. Stream 3 comprises the total fluid input (F₁) into system 1. In reality there can be multiple separate input streams that cumulatively constitute F₁.

Column 2 has a lower liquid sump region 4 internally thereof. The liquid accumulation in sump 4 is measured by a conventional liquid level instrument 5 which gives the operator a reading of the measured liquid level (L₁) in sump 4.

Column 2 also has a reflux tank 10 which is operatively connected in a fluid flow manner with the upper overhead region of the tower by way of conduits 11 and 12, pipe 11 carrying a heat exchanger 13 for heating fluid, as desired, that has been removed from top 14 of tower 2.

The liquid accumulation in tank 10 is measured by a conventional liquid level instrument 15 which gives the operator a reading of the measured liquid level (L₂) in tank 10.

Liquid removed from tank 10 by way of pipe 16 (F₂) is part of the total liquid actually removed from system 1.

Liquid is also removed from bottom 20 of tower 2 by way of pipe 21. Part of this liquid is diverted by pipe 22 to heat exchanger 23 wherein it can be heated as desired and returned by way of pipe 24 to tower 2 to provide additional heat input into the tower as needed. The remainder of the liquid not returned to sump 4 is removed from the system via pipe 25. Liquid removed from sump 4 by way of pipe 25 (F₃) is the remainder of the total liquid actually removed from system 1.

F₁ represents the total liquid input into system 1 while F₂ plus F₃ represents the total liquid removed from system 1. In addition, at any given point in time there is an inventory of liquid inside tower 2 as it is passing through system 1.

Thus, a material balance around system 1 is represented by the formula total fluid flow-in (F₁) minus total fluid flow-out (F₂ plus F₃) equals the total liquid accumulation inside system 1. The inlet and outlet flows F₁, F₂, and F₃ are typically measured by flow meters well known in the art.

In the further detailed description of the prior art and this invention, some terms must first be defined.

“Liquid accumulation” in respect of system 1 of FIG. 1 equals the measured liquid accumulation (the liquid in the sump 4 at the bottom of tower 2 plus the liquid in the overhead reflux tank 10, i.e., L₁+L₂) plus the unmeasured liquid in the interior of the column (liquid accumulated on the internals of the column, e.g., trays and downcomers, structured packing, and the like).

“Measured liquid accumulation” is determined in a conventional manner from instrument measurements of the liquid levels, L₁ and L₂, using level indicator instruments 5 and 15 that are well known in the art and operatively connected, respectively, to sump 4 at the bottom of tower 2 by sensing lines 26 and 27 and to overhead reflux tank 10 by sensing lines 28 and 29.

Under steady state operating conditions the inlet liquid flow(s) and outlet liquid flow(s) are in balance. When the operation of system 1 is not in the steady state, liquid accumulates or depletes, as the case may be, in sump 4, tank 10, and/or tower 2 internals. While the measured liquid accumulations in sump 4 and tank 10 are readily measured by the changes in the respective level measurements (L₁ and L₂), the liquid accumulation on the internals of tower 2 are not easily observed, much less measured.

“Unmeasured liquid accumulation” is equal to the total liquid flow into the system of FIG. 1 minus the measured liquid accumulation. That is to say, it is F₁ minus F₂ minus F₃ minus the measured liquid accumulation obtained from L₁ and L₂. Unmeasured liquid accumulation is, therefore, the accumulation of liquid within tower 2 that is neither observed nor readily measured, but only calculated.

Unmeasured liquid accumulation is synonymous with the term “imbalance.”

“Total unmeasured liquid accumulation” or “total imbalance” is equal to the summation over time of individual imbalances, i.e., the mathematical integration of individual imbalances over time.

Total unmeasured liquid accumulation (total imbalance) should be essentially zero at steady state, meaning as much unmeasured liquid is leaving the system as new unmeasured liquid is accumulated in the system.

However, it has been discovered that such is not the case even at steady state process conditions due to 1) measuring error in the instruments that are measuring the actual fluid flows into and out of the system of FIG. 1, 2) measuring error in the instruments measuring the actual liquid levels L₁ and L₂ in the tower sump 4 and reflux tank 10, and 3) error drift introduced into such measuring instruments by routine re-calibration thereof, equipment start up, and/or instrument maintenance.

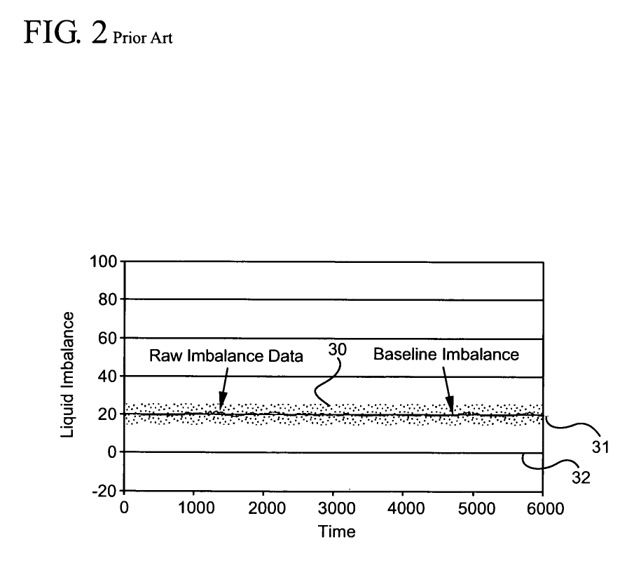

Even though ideally the total unmeasured liquid accumulation (total imbalance) should be essentially zero at steady state, in reality, the total imbalance has been found not to be distributed around zero, but rather exhibits a non-zero distribution effect as shown in FIG. 2.

In FIGS. 2 through 8 the arrows on the abscissa and ordinate axes indicate the direction of increasing magnitude for the indicated units. Absolute values for various data represented in FIGS. 2 through 8 are not necessary to inform the art, but rather would be confusing and detract from an understanding of the invention and its benefits. The directional movement of the corrected data pursuant to this invention is the inventive concept to be understood from these Figures.

FIG. 2 shows a plot comparing imbalance magnitude versus time. A plurality of raw imbalance data points 30 obtained from the system of FIG. 1 when operated without the benefits of this invention are shown in FIG. 2. A time average baseline imbalance for points 30 is shown as line base line 31.

Ideally, the total unmeasured liquid accumulation (total imbalance) should be essentially zero at steady state, i.e., distributed around the zero line 32. However, data points 30 and baseline 31 demonstrate a non-zero effect, i.e., consistent distribution significantly above the desired zero effect line 32.

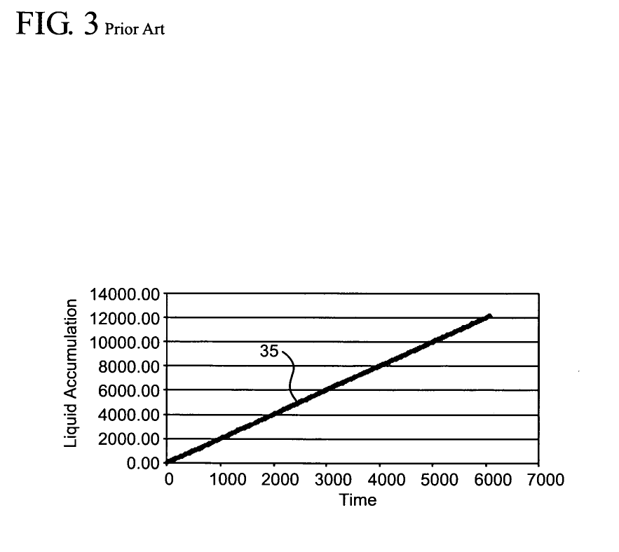

Mathematically integrating the non-zero effect data points 30 of FIG. 2 over time indicates a steady buildup of liquid in tower 2. This is shown in FIG. 3, line 35. Thus, an operator relying on the uncorrected data of FIG. 2 and the plot of FIG. 3 would be led to believe that tower 2 was filling with liquid which, in reality, is a false indication because of the non-zero effect for data points 30 shown in FIG. 2.

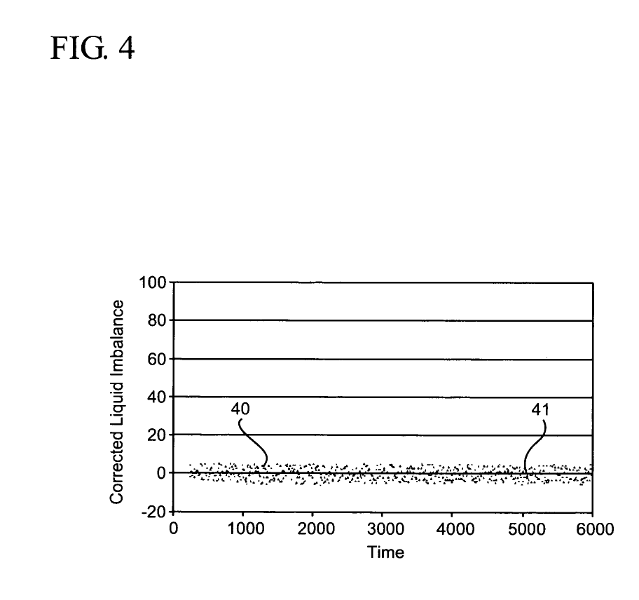

This invention, among other things, corrects the raw data points 30 to eliminate the foregoing non-zero effect, and to produce a data point distribution around zero, see FIG. 4. This is accomplished by comparing the imbalance in the tower to a baseline imbalance value other than zero and correcting for current imbalance shifts.

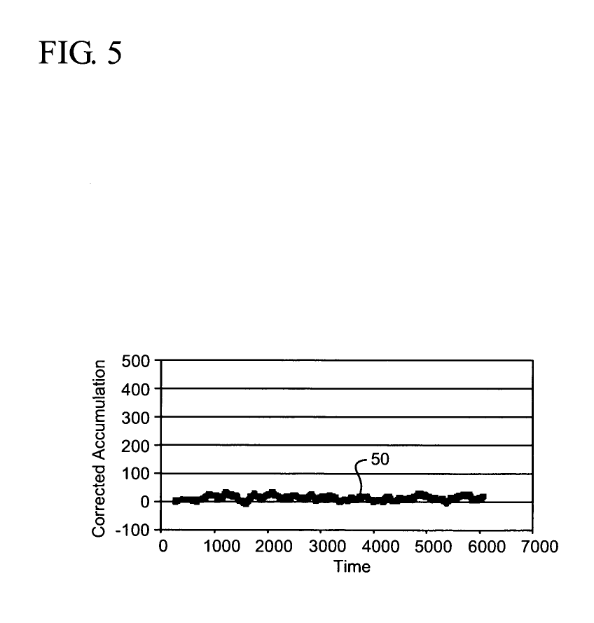

Baseline imbalance line 31 is a time averaged value of current imbalances. When the difference between the current (real time) imbalance and the baseline imbalance is plotted over time, the values are distributed around zero as shown in FIG. 4. FIG. 4 shows corrected data points 40 to be distributed around the zero line 41. When this calculated difference (instantaneous liquid accumulation) is mathematically integrated over time, the liquid accumulation in tower 2 is steady (essentially horizontal) as shown in FIG. 5, line 50, and does not falsely indicate a steady increase of liquid in tower 2 as does line 35 in FIG. 3.

Thus, the effect of instrument measurement error is negated by this invention by comparing the current imbalance to its calculated baseline.

The time horizon over which the baseline is calculated affects the results of the calculation. A short time horizon will result in the baseline moving with the current imbalance while a long time horizon will make it stay relatively steady. Too long a time horizon may result in slow baseline changes and may not be appropriate for situations like instrument recalibrations or unit startup. Over a longer time horizons, e.g., four to six hours, towers are typically steady state in operation.

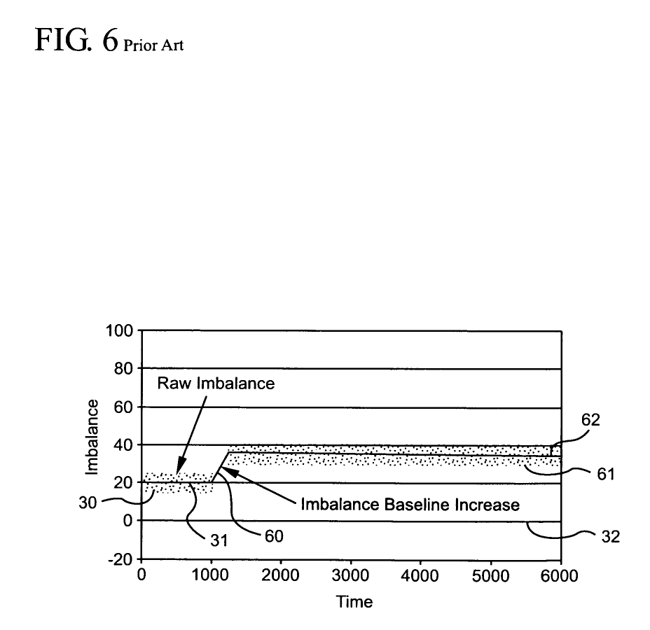

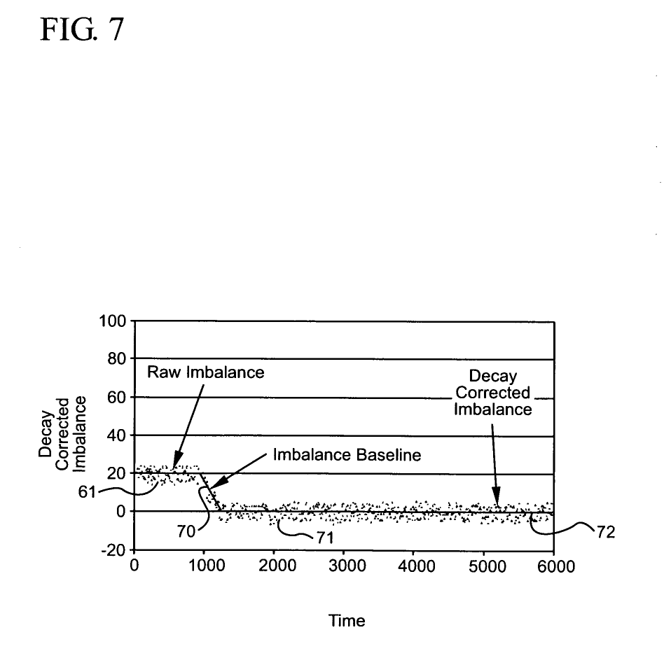

The part of the invention so far described addresses instrument measurement error. However, when instruments are routinely recalibrated, the current imbalance shifts to a new level. Since the baseline is a time averaged value of the current imbalance, it takes some time for the baseline to catch up to this new level. In the interim any total liquid accumulation value increases due to the integration of the finite difference between the baseline and the current imbalance. This continues until the baseline catches up to the new level and once that point is reached, the total liquid accumulation value lines out. FIGS. 6 and 7 illustrate this effect.

In FIG. 6 it is shown that due to, for example, a routine instrument recalibration, raw data points 30 and baseline 31 of FIG. 2 increased in magnitude, as represented by line 60, to a new level represented by new raw data points 61 and new baseline 62. Thus, the uncorrected data points 61 and baseline 62 are even more removed from zero line 32 than were original raw data points 30 and baseline 31.

In FIG. 7 it is shown that, with the use of the decay factor aspect of this invention, the newly elevated raw data points 61 are reduced, as represented by line 70, to a lower more realistic level represented by raw data points 71 and new baseline 72, base line 72 being essentially equivalent to zero line 41 of FIG. 4.

Thus, even under steady operating conditions, the total liquid accumulation value can change to a new level due to instrument recalibration, unit startup, instrument maintenance, and the like.

This apparent liquid accumulation has to be corrected since this is not a reflection of real liquid accumulation, but only a manifestation of instrument or unit change. This invention, therefore, additionally dynamically corrects for this type of error by introducing a decay factor component.

The decay factor of this invention equals e^{(-t/tau)} where “e” is Euler's constant (2.7181 . . . ), “t” is the time calculation execution interval, and “tau” is a time constant interval over which the liquid accumulation decays to about 63% of its value.

The total liquid accumulation is then calculated pursuant to the formula:

decay factor times the previous total liquid accumulation value plus the current liquid accumulation.

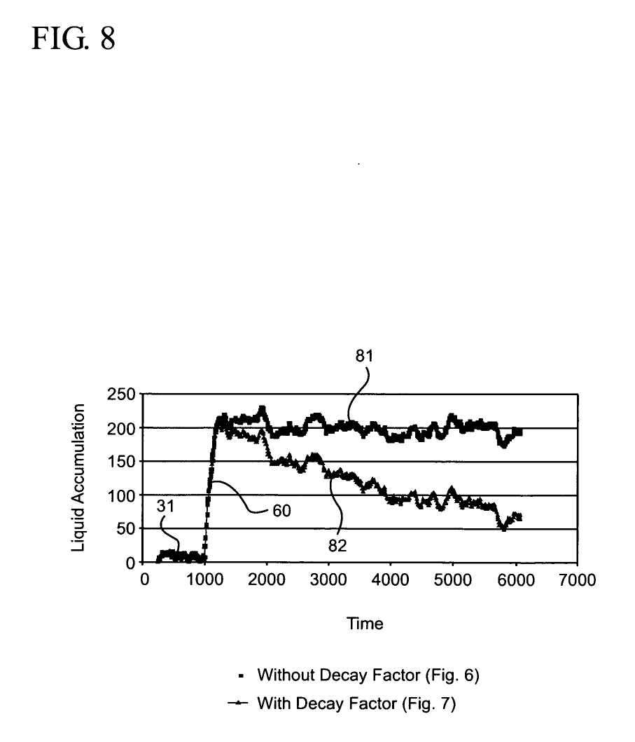

The decay factor constantly works toward pushing the total liquid accumulation value towards the zero line 41 of FIG. 4. The decay factor should be chosen such that it reduces the total liquid accumulation value slowly. A good starting value for the decay factor is one that results in a decay of about 95% of the original value over a few days, e.g., three days (0.9993). By choosing a slow decay rate any residual value is removed slowly over time while not significantly interfering with the result in case of a real liquid accumulation. FIG. 8 shows the increase 60 of FIG. 6 and the results thereafter with, line 82, and without, line 81, the decay factor of this invention.

FIG. 8 shows that plot 81, which enjoys no decay factor correction, stays at an elevated level which is in reality a false indication. On the other hand FIG. 8 additionally shows that plot 82, which enjoys the benefit of the decay factor of this invention, gradually declines to a lower level that is more representative of the real liquid situation in system 1.

This invention achieves its zero effect correction results using the following steps:

1) Calculate the current (real time) imbalance (current total flow-in (F₁) minus current total flow-out (F₂₊₃), minus current measured liquid accumulation).

2) Calculate a base line imbalance using a time averaged value of prior imbalances.

3) Calculate the current liquid accumulation (current imbalance minus the baseline imbalance).

By comparing the current imbalance to the baseline imbalance the effects of instrument measuring error is substantially, if not wholly, negated.

The correction for current imbalance shifts due to measuring instrument re-calibration, startups, and/or instrument maintenance is accomplished by introducing the aforesaid decay factor into the calculation of the current total liquid accumulation (measured and unmeasured liquid accumulations).

This is accomplished by way of the formula—current total liquid accumulation equals the decay factor (e^{(-t/tau)}) times the next previous liquid accumulation value plus the current liquid accumulation value. In the decay factor e^{(-t/tau)}), “e” is Euler's constant aforesaid; “t” is the calculation execution frequency, i.e., how often the calculation is run, for example, once a minute; and tau is a time constant over which the total liquid accumulation decays to at least 63 percent of its original value, the original value being based on observations of actual liquid overfill incidents of the column(s) in question.

The foregoing decay factor component allows the time averaged baseline to catch up to the new measuring level introduced by the re-calibration, etc., FIG. 7, baseline 72 and FIG. 8, plot 82. When the baseline catches up, FIG. 7, line 72, a zero distribution is again achieved, FIG. 7, corrected data points 71. The net effect of the use of the foregoing decay factor is gradually to adjust the calculated total liquid accumulation from a misleading result, FIG. 8, plot 81, back to a result that is representative of the actual liquid accumulation in the column, FIG. 8, plot 82.

Accordingly, the combination of the foregoing set of calculations 1) through 3) to correct for non-zero effects due to measuring instrument error(s) and the foregoing decay factor component to correct for instrument signal aberrations provides a robust, dynamic method for operating a thermal distillation tower system to reduce, if not eliminate, liquid overfill incidents in respect of the tower itself.

I claim:

1. A method for protecting a thermal distillation column system from liquid over fill, said system comprising a thermal distillation column having an overhead section and a bottoms section, said overhead section having an overhead liquid reflux tank in fluid communication with said column, said bottoms section having a liquid bottoms sump, said method comprising
(a) measuring over time the total liquid flow into said system, the total liquid flow out of said system, and the liquid levels in said bottoms sump and reflux tank to obtain measured liquid accumulation data for said system over time,
(b) providing a digital computer with a database including data obtained from step (a) and also including previous total liquid accumulation data,
using said digital computer to:
(c) calculate a measured liquid accumulation based on the measured liquid levels over time of said bottoms sump and said reflux tank obtained from step (a),
(d) calculate a current imbalance using the formula—total liquid flow into said system minus total liquid flow out of said system minus said measured liquid accumulation obtained from step (c),
(e) calculate a baseline imbalance based on time averaged values of said current imbalances obtained from step (d),
(f) calculate a current liquid accumulation using the formula—current imbalance of step (d) minus base line imbalance of step (e),
(g) calculate a current total liquid accumulation using a decay factor formula—e^{(-t/tau)}, where “e” is Euler's constant, “t” is a time calculation interval and “tau” is a time constant over which the total liquid accumulation decays to at least 63 percent of its original value, times the total liquid accumulation previous to step (f) plus said current liquid accumulation of step (f), and
controlling the total liquid content of said system based on the current total liquid accumulation data obtained from step (g).

2. The method of claim 1 wherein said decay factor is from about 0.9970 to about 0.9996.

3. The method of claim 1 wherein said decay factor is about 0.9993.
